(19) United States
(12) Patent Application Publication
(10) Pub. No.: US 2025/0270070 A1
(43) Pub. Date: Aug. 28, 2025

(54) DEVICE FOR REDUCING BOUNCING OF ELEVATOR CAR

(71) Applicant: HYUNDAI ELEVATOR CO., LTD, Chungcheongbuk-do (KR)

(72) Inventors: Hyun Goo KIM, Chungcheongbuk-do (KR); Sang Hyuk LEE, Chungcheongbuk-do (KR); Ik Sung CHOI, Chungcheongbuk-do (KR); Woo Sok CHANG, Chungcheongbuk-do (KR)

(21) Appl. No.: 18/858,031

(22) PCT Filed: Apr. 3, 2023
(86) PCT No.: PCT/KR2023/004458

§ 371 Date: Oct. 18, 2024

(30) Foreign Application Priority Data
Apr. 22, 2022 (KR) 10-2022-0050374
Mar. 23, 2023 (KR) 10-2023-0037962

(51) Int. Cl. B66B 7/04

(52) U.S. Cl. CPC B66B 7/044

(57) ABSTRACT

Disclosed is a bouncing reduction device for elevator cars. The bouncing reduction device for elevator cars includes a friction module configured to be pressed against a guide rail while an elevator car is stopped at a floor, thereby reducing bouncing experienced by the elevator during boarding and alighting of passengers using frictional force generated between the friction module and the guide rail, can reduce noise from contact between a friction body and the guide rail while maximizing frictional force therebetween by adjusting the moving speed and pressing force of the friction body through control of a friction drive unit by a PWM control method, thereby ensuring improved overall performance and quality, and can be easily retrofitted to existing elevator cars without any structural modifications.

### TECHNICAL FIELD

The present invention relates to a bouncing reduction device for elevator cars. More particularly, the present invention relates to a bouncing reduction device for elevator cars that includes a friction module configured to be pressed against a guide rail while an elevator car is stopped at a floor, thereby reducing bouncing experienced by the elevator during boarding and alighting of passengers using frictional force generated between the friction module and the guide rail, can reduce noise from contact between a friction body and the guide rail while maximizing frictional force therebetween by adjusting the moving speed and pressing force of the friction body through control of a friction drive unit by a PWM control method, thereby ensuring improved overall performance and quality, and can be easily retrofitted to existing elevator cars without any structural modifications.

### BACKGROUND ART

In various high-rise buildings for residential and business purposes, elevators are installed to facilitate vertical movement of passengers visiting such buildings.

A typical elevator includes an elevator car configured to be movable within a hoistway, a counterweight connected to the elevator car by a wire rope, and a traction machine disposed at the top of the hoistway to frictionally contact the wire rope to move the elevator car and the counterweight up and down through forward and reverse rotation of the wire rope.

The elevator car is moved up and down along a guided path provided by a guide roller device configured to roll on a guide rail in the hoistway and is supported by being suspended from the wire rope during upward and downward movement thereof. Accordingly, when passengers and cargo enter and leave the elevator car stopped at a floor, the elevator car experiences transient vertical vibration.

This transient vertical vibration experienced by the elevator car when passengers and cargo enter and leave the elevator car is commonly referred to as bouncing. Such bouncing, if sustained, can lead to passenger discomfort or anxiety, thus negatively affecting perceived product quality.

Typical methods to mitigate such a bouncing phenomenon involve modifying the entire elevator system, such as adding wire ropes or belts or replacing existing wire ropes or belts with those having higher elastic moduli. However, these approaches are time-consuming and costly and are limited in application by site conditions.

### DISCLOSURE

### Technical Problem

Embodiments of the present invention are conceived to solve such problems in the art and it is one aspect of the present invention to provide a bouncing reduction device for elevator cars that includes a friction module configured to pressed against a guide rail while an elevator car is stopped at a floor, thereby reducing bouncing experienced by the elevator car during passengers boarding and alighting using frictional force generated between the guide rail and the friction module.

It is another object of the present invention to provide a bouncing reduction device for elevator cars that can reduce noise from contact between a friction body and a guide rail while maximizing frictional force therebetween by adjusting the moving speed and pressing force of the friction body through control of a friction drive unit by a PWM control method, thereby ensuring improved overall performance and quality.

It is a further object of the present invention to provide a bouncing reduction device for elevator cars that ensures improved operational safety by allowing a friction drive unit to be activated or deactivated according to a door open/close signal of an elevator car to allow precise control of the friction drive unit based on the operating state of the elevator car.

It is yet another object of the present invention to provide a bouncing reduction device for elevator cars that can ensure long-term stable use without failure or damage by ensuring stable operation of a friction body and a friction drive unit connected thereto by preventing transfer of shear loads to the friction body and displacement of the friction body while the friction body contacts the guide rail.

It is yet another object of the present invention to provide a bouncing reduction device for elevator cars that can improve installation convenience through a dedicated coupling module, can be easily retrofitted to existing elevator cars without any structural modifications, and can enhance operational accuracy by allowing precise initial setup.

### Technical Solution

In accordance with one aspect of the present invention, there is provided a bouncing reduction device for elevator cars that is configured to reduce a bouncing phenomenon in which an elevator car configured to move along a guide rail in a hoistway vibrates in a vertical direction when passengers board and alight from the elevator car. The bouncing reduction device includes: a friction module coupled to the elevator to be pressed against the guide rail; a friction drive unit coupled to the elevator car and configured to force the friction module to be pressed against the guide rail; a drive control unit configured to control activation and deactivation of the friction drive unit in response to an operating state signal of the elevator car from a separate central control panel, wherein the friction module is pressed against the guide rail upon activation of the friction drive unit and is separated from the guide rail upon deactivation of the friction drive unit.

Here, the friction module may be moved to be pressed against the guide rail upon activation of the friction drive unit and may be resiliently returned to an original position thereof to be separated from the guide rail upon deactivation of the friction drive unit.

The friction module may include: a friction body coupled to one side of the friction drive unit to be movable back and forth and configured to be moved forward and pressed against the guide rail by activation of the friction drive unit; and an elastic spring configured to apply elastic force to the friction body in a direction away from the guide rail.

The friction body may include: a movable block coupled to the one side of the friction drive unit to be movable back and forth; and a friction pad coupled to a front surface of the movable block to be brought into contact with the guide rail.

The friction drive unit may include: a solenoid housing having an electric coil disposed therein; and a solenoid mover coupled to the solenoid housing to be movable back and forth and configured to be linearly moved by change in power supplied to the electric coil, wherein the friction body may be pushed forward away from the solenoid housing by the solenoid mover upon forward movement of the solenoid mover.

The drive control unit may be configured to control the friction drive unit by changing power supplied from a separate power supply to the electric coil.

During activation of the friction drive, the drive control unit may regulate power supplied to the electric coil by a PWM control method in which a PWM duty ratio of power supplied to the electric coil is adjusted to a relatively small value while the solenoid mover is moved forward until the friction body makes full contact with the guide rail, and is adjusted to a relatively large value after full contact is made between the friction body and the guide rail.

The bouncing reduction device may further include: a vertical reinforcing guide configured to guide the friction body of the friction module to prevent vertical displacement of the friction body while the friction body contacts the guide rail.

The drive control unit may be configured to receive a door open/close signal of the elevator car from the central control panel and to activate or deactivate the friction drive unit according to the door open/close signal.

The bouncing reduction device may further include: an operation detection sensor configured to detect an operating state of the friction drive unit, wherein the drive control unit may be configured to receive a detection signal of the operation detection sensor and to transmit the detection signal to the central control panel.

The drive control unit may be configured to receive an operating intensity signal of the friction drive unit from the central control panel and to change operating intensity of the friction drive unit according to the received operating intensity signal.

The friction drive unit may be detachably coupled to a guide roller device of the elevator car through a separate coupling module, and the friction module is coupled to the friction drive unit to be movable back and forth by the friction drive unit.

The coupling module may include: a support plate detachably coupled to one end of the guide roller device; and an adapter block coupled to one surface of the support plate and having an upper portion allowing the friction drive unit to be seated thereon and coupled thereto.

The adapter block may be configured to adjust a position of the friction drive unit in a front-to-rear direction with respect to the guide rail, with the friction drive unit seated on the adapter block.

The support plate may extend in a horizontal direction to cover a space outside a guide roller of the guide roller device.

### Advantageous Effects

According to the present invention, with the friction module configured to be pressed against a guide rail while an elevator car is stopped at a floor, it is possible to reduce bouncing experienced by the elevator car during boarding or alighting of passengers using frictional force generated between the guide rail and the friction module.

In addition, since the moving speed and pressing force of the friction body are adjusted through control of a friction drive unit by a PWM control method, it is possible to reduce noise from contact between the friction body and the guide rail while maximizing frictional force therebetween, thereby ensuring improved overall performance and quality.

In addition, since the friction drive unit is activated or deactivated according to a door open/close signal of the elevator car to allow precise control of the friction drive unit based on the operating state of the elevator car, it is possible to ensure improved operational safety.

In addition, since it is possible to ensure stable operation of the friction body and the friction drive unit connected thereto by preventing transfer of shear loads to the friction body and displacement of the friction body while the friction body contacts the guide rail, long-term stable use without failure or damage can be ensured.

In addition, with the coupling module, the bouncing reduction device according to the present invention can improve installation convenience, can be easily retrofitted to existing elevator cars without any structural modifications, and can enhance operational accuracy by allowing precise initial setup.

### DESCRIPTION OF DRAWINGS

FIG. 1 is a schematic view illustrating an elevator car installed with a bouncing reduction device for elevator cars according to one embodiment of the present invention.

FIG. 2 is a schematic perspective view illustrating the appearance of the bouncing reduction device for elevator cars.

FIG. 3 is a schematic block diagram illustrating control-related components of the bouncing reduction device for elevator cars.

FIG. 4 is a schematic horizontal sectional view illustrating the internal structure of the bouncing reduction device for elevator cars.

FIG. 5 is a schematic horizontal sectional view illustrating operation of the bouncing reduction device for elevator cars.

FIG. 6 is a schematic vertical sectional illustrating the internal structure of the bouncing reduction device for elevator cars.

FIG. 7 is a schematic horizontal sectional view illustrating the internal structure of a bouncing reduction device for elevator cars according to another embodiment of the present invention.

FIG. 8 is a diagram illustrating a PWM control method used in the bouncing reduction device for elevator cars according to one embodiment of the present invention.

FIG. 9 is a partial exploded perspective view of a coupling module of the bouncing reduction device for elevator cars according to one embodiment of the present invention.

FIG. 10 is a schematic side view illustrating a coupling structure of the bouncing reduction device for elevator cars according to one embodiment of the present invention.

### BEST MODE

Hereinafter, exemplary embodiments of the present invention will be described in detail with reference to the accompanying drawings. Like components will be denoted by like reference numerals throughout the drawings. In addition, detailed descriptions of known functions and constructions which may unnecessarily obscure the subject matter of the invention will be omitted.

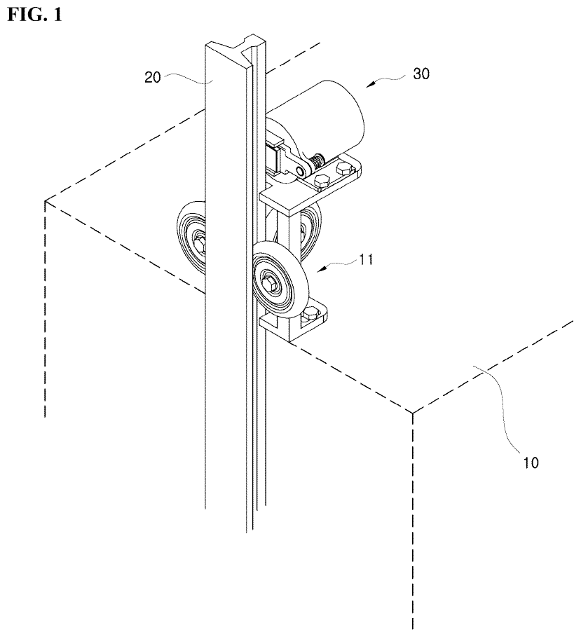

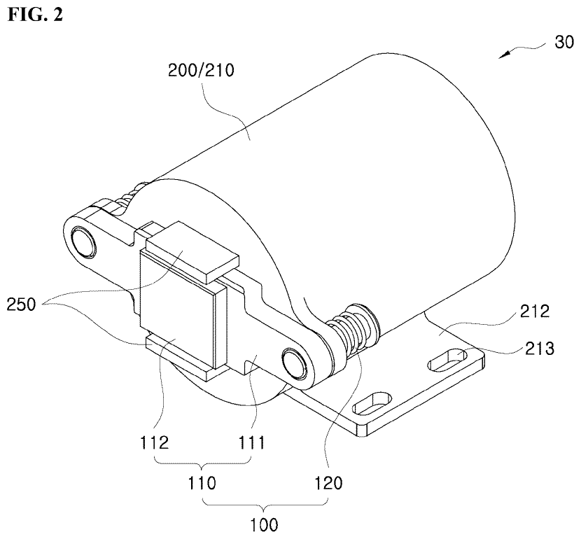

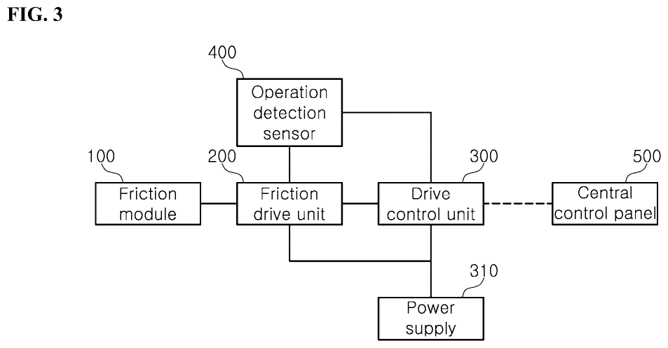

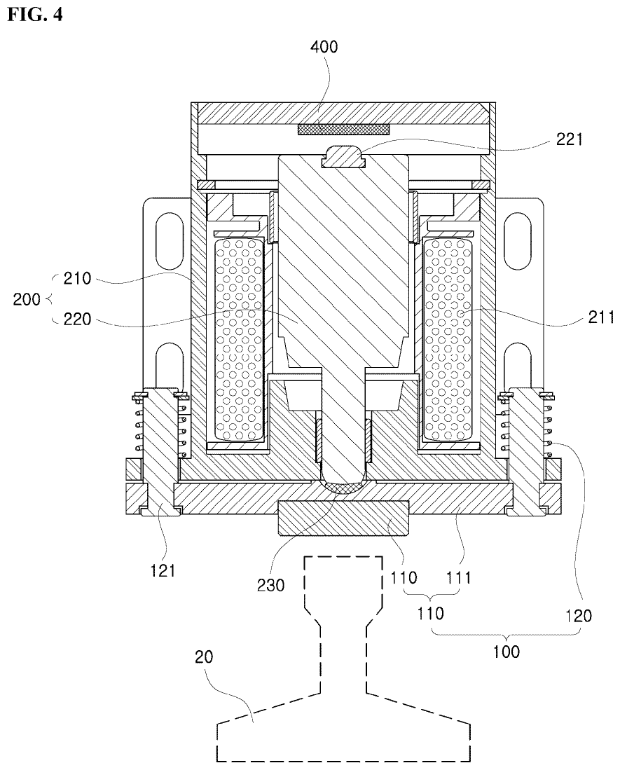

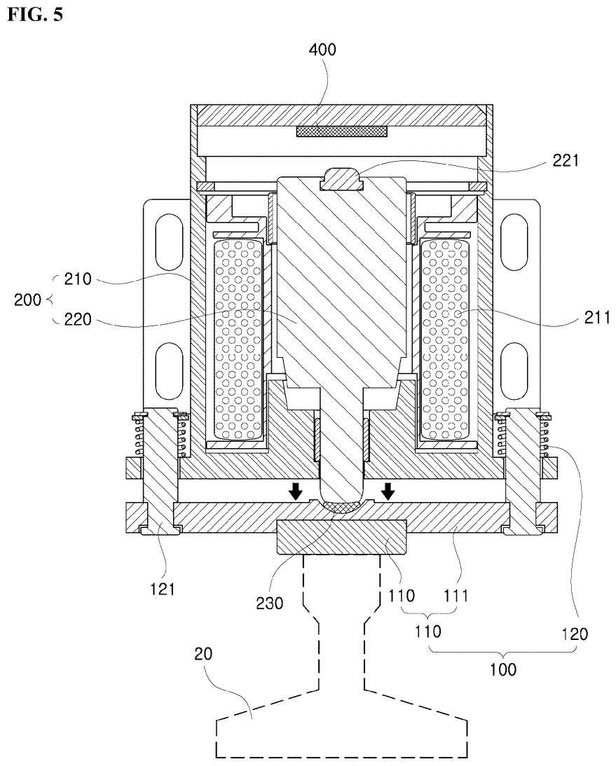

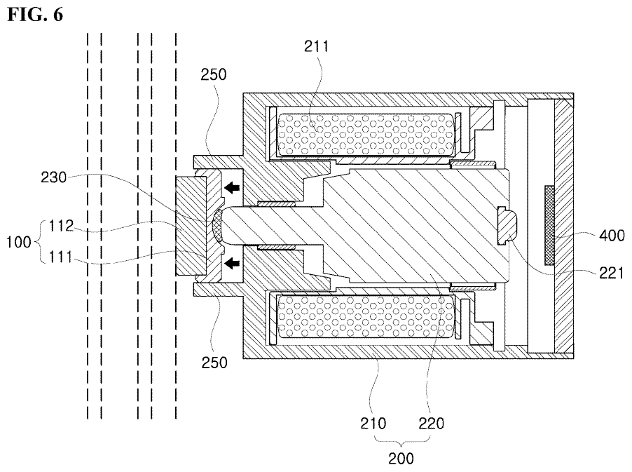

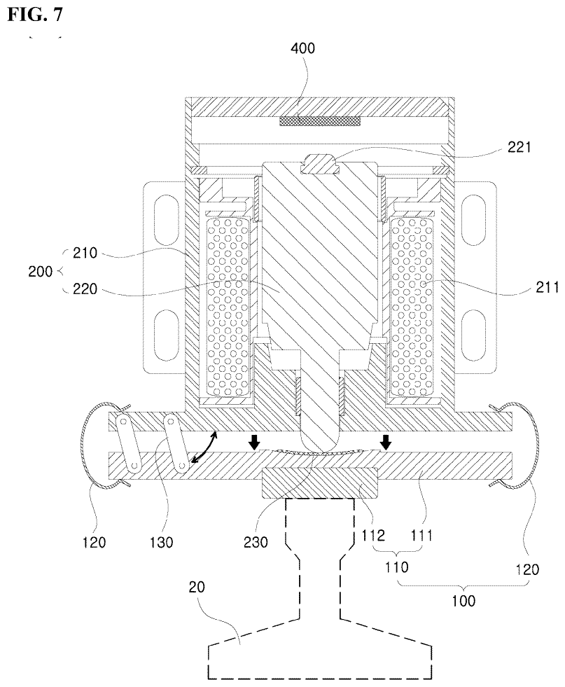

FIG. 1 is a schematic view illustrating an elevator car equipped with a bouncing reduction device for elevator cars according to one embodiment of the present invention, FIG. 2 is a schematic perspective view illustrating the appearance of the bouncing reduction device for elevator cars, FIG. 3 is a schematic block diagram illustrating control-related components of the bouncing reduction device for elevator cars, FIG. 4 is a schematic horizontal sectional view illustrating the internal structure of the bouncing reduction device for elevator cars, FIG. 5 is a schematic horizontal sectional view illustrating operation of the bouncing reduction device for elevator cars, FIG. 6 is a schematic vertical sectional illustrating the internal structure of the bouncing reduction device for elevator cars, and FIG. 7 is a schematic horizontal sectional view illustrating the internal structure of a bouncing reduction device for elevator cars according to another embodiment of the present invention.

A bouncing reduction device 30 for elevator cars according to one embodiment of the present invention is a device designed to reduce a bouncing phenomenon in which an elevator car 10 configured to move along a guide rail 20 in a hoistway vibrates in a vertical direction when passengers board and alight from the elevator car 10, and includes a friction module 100, a friction drive unit 200, and a drive control unit 300.

The friction module 100 is coupled to the elevator car 10 to be pressed against the guide rail 20 to generate frictional force. As shown in FIG. 1, the elevator car 10 is provided at an upper end thereof with a guide roller device 11 configured to guide a vertical movement path of the elevator car 10 while rolling on the guide rail 20. The friction module 100 may be coupled to an upper portion of the guide roller device 11. However, it should be understood that the present invention is not limited thereto and the friction module 100 may be disposed at a location separate from the guide roller device 11, such as a middle portion of the elevator car 10.

The friction drive unit 200 is coupled to the elevator car 10 and is configured to force the friction module 100 to be pressed against the guide rail 20.

Accordingly, the friction module 100 is operable to be pressed against the guide rail 20 upon activation of the friction drive unit 200 and separated from the guide rail 20 upon deactivation of the friction drive unit 200.

More specifically, the friction module 100 may be moved to be pressed against the guide rail 20 upon activation of the friction drive unit 200 and may be resiliently returned to an original position thereof to be separated from the guide rail 20 upon deactivation of the friction drive unit 200.

In the following, the configuration of the friction module 100 and the friction drive unit 200 will be described in more detail. Referring to FIG. 4 to FIG. 6, the friction module 100 includes a friction body 110 and an elastic spring 120.

The friction body 110 is coupled to one side of the friction drive unit 200 to be movable back and forth and is configured to be moved forward and pressed against the guide rail 20 by activation of the friction drive unit 200. The friction body 110 may include a movable block 111 coupled to one side of the friction drive unit 200 to be movable back and forth and a friction pad 112 coupled to a front surface of the movable block 111 to be brought into contact with the guide rail 20.

The elastic spring 120 is mounted on the friction body 110 to apply elastic force to the friction body 110 in a direction away from the guide rail 20 and may be implemented in various forms, such as a coil spring, a leaf spring, and the like. In this embodiment, a coil spring is used as the elastic spring 120, wherein a separate guide rod 121 having one end coupled to the friction body 110 and the other end passing through the friction drive unit 200 may be disposed at a center of the coil spring, and the coil spring may be configured to resiliently push the guide rod 121 in one direction (a direction in which the friction body 110 is moved away from the guide rail 20).

As such, since the friction body 110 is detachably coupled to the friction drive unit 200 through the guide rod 121 and is resiliently supported on the friction drive unit 200 by the elastic spring 120, the friction pad 112 can be easily replaced by separating the friction body 110 from the friction drive unit 200 when the friction pad 112 wears out due to extended use.

According to one embodiment of the present invention, the friction drive unit 200 may be a solenoid type friction drive unit and may include: a solenoid housing 210 having an electric coil 211 disposed therein; and a solenoid mover 220 coupled to the solenoid housing 210 to be movable back and forth and configured to be linearly moved by change in power supplied to the electric coil 211.

Here, the friction body 110 is movably coupled to a front of the solenoid housing 210 and may be configured to be pushed forward away from the solenoid housing 210 by the solenoid mover 220 upon forward movement of the solenoid mover 220.

Although the friction body 110 may be fixedly coupled to a front end of the solenoid mover 220 to be movable in unison with the solenoid mover, it is desirable that the friction body 110 be provided in a detachable manner to facilitate removal and replacement thereof, as described above. Furthermore, since the friction body 110 and the solenoid mover 220 are separate from each other, it is possible to prevent external force transferred to the friction body 110 on the guide rail 20 from being directly transferred to the solenoid mover 220, thereby preventing damage to or failure of the friction drive unit 200 including the solenoid mover 220 due to external force.

Here, a separate cushioning member 230 may be interposed between the solenoid mover 220 and the movable block 111. The cushioning member 230 may be fixedly mounted on a rear surface of the movable block 111. The cushioning member 230 serves to reduce contact noise between the solenoid mover 220 and the rear surface of the movable block 111 that can occur when the solenoid mover 220 is moved forward.

When the friction drive unit 200 is activated by supplying power to the electric coil 211 of the solenoid housing 210, the solenoid mover 220 is moved forward, as shown in FIG. 5, which, in turn, forces the friction body 110 to be moved forward such that the friction pad 112 of the friction body 110 is pressed against one side of the guide rail 20. As the friction body 110 is pressed against the guide rail 20, frictional force is generated between the friction body 110 and the guide rail 20 to cancel out vertical vibration transmitted to the elevator car 10 during boarding and alighting of passengers, thereby reducing bouncing of the elevator car 10.

Thereafter, when the friction drive unit 200 is deactivated by cutting off power supply to the electric coil 211 of the solenoid housing 210, the friction body 110 is moved backward away from the guide rail 20 by elastic force of the elastic spring 120 and is returned to an original position thereof adjacent to the one side of the solenoid housing 210, as shown in FIG. 4.

The drive control unit 300 receives an operating state signal of the elevator car 10 from a separate central control panel 500 and controls activation and deactivation of the friction drive unit 200 according to the operating state signal. Specifically, the drive control unit 300 is configured to control the friction drive unit 200 by changing power supplied from a separate power supply 310 to the electric coil 211. That is, the drive control unit 300 activates the friction drive unit 200 by allowing power to be supplied to the electric coil 211 and deactivates the friction drive unit 200 by cutting off power supply to the electric coil 211, as described above.

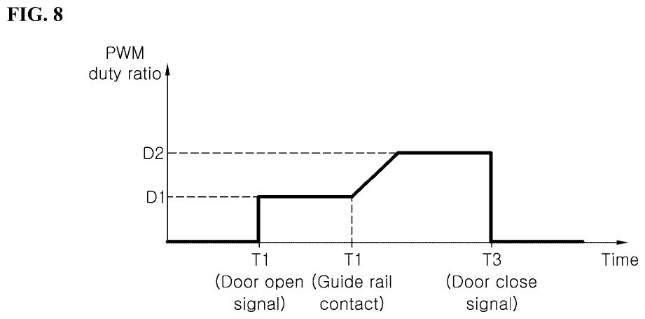

Here, the drive control unit 300 may regulate power supplied to the electric coil 211 by a PWM control method, which will be described in detail further below with reference to FIG. 8.

As described above, the drive control unit 300 receives an operating state signal of the elevator car 10 from the central control panel 500 and controls the friction drive unit 200 according to the received operating state signal. Here, the operating state signal of the elevator car 10 transmitted from the central control panel 500 may be set as a door open/close signal of the elevator car 10.

For example, the drive control unit 300 may be configured to activate the friction drive unit 200 upon receiving a door open signal from the central control panel 500 and deactivate the friction drive unit 200 upon receiving a door close signal from the central control panel 500.

Since the bouncing reduction device 30 according to the present invention is intended to reduce vertical vibration (bouncing) of the elevator car 10 that occurs when passengers board and alight from the elevator car 10 stopped at a floor, the friction drive unit 200 is required to remain activated from just before passengers board and alight from the elevator car 10 until just after the passengers have finished boarding and alighting. Since the process of passengers boarding and alighting from the elevator car occurs based on operation of a door of the elevator car 10, the drive control unit may control activation and deactivation of the friction drive unit 200 based on the door open/close signal.

In particular, if the elevator car 10 starts moving while the friction drive unit 200 is still activated, the friction body 110 remains pressed against the guide rail 20 even after initiation of movement of the elevator car 10. Therefore, it is desirable to deactivate the friction drive unit 200 before the elevator car starts moving. If activation and deactivation of the friction drive unit 200 are controlled solely based on a stop signal and a movement start signal of the elevator car 10, deactivation of the friction drive unit 200 occurs simultaneously with initiation of movement of the elevator car, which can lead to a situation in which the elevator car 10 starts moving with the friction body still pressed against the guide rail due to minor errors or the like. Therefore, it is desirable to control activation and deactivation of the friction drive unit 200 based on the door open/close signal, as described above.

However, it should be understood that the present invention is not limited thereto and the drive control unit 300 may be configured to receive not only the door open/close signal but also the stop signal and the movement start signal of the elevator car 10 to control the friction drive unit 200 through a comprehensive determination based on these signals. For example, the drive control unit 300 may be configured to activate the friction drive unit 200 upon receiving both the stop signal and the door open signal of the elevator car 10 and deactivate the friction drive unit 200 upon receiving either the door close signal 10 or the movement start signal of the elevator car 10.

The central control panel 500 may be configured to transmit a signal specifying operating intensity of the friction drive unit 200 to the drive control unit 300, and the drive control unit 300 may be configured to control the friction drive unit 200 in response to the operating intensity signal. For example, when the central control panel 500 transmits an operating intensity signal requesting to increase frictional force between the friction body 100 and the guide rail 20, the drive control unit 300 may control the solenoid mover 220 to apply more pressure to the friction body 110 by adjusting power supplied to the electric coil 211 of the friction drive unit 200. Conversely, when the central control panel 500 transmits an operating intensity signal requesting to reduce frictional force between the friction body 100 and the guide rail 20, the drive control unit 300 may control the solenoid mover 220 to apply less pressure to the friction body 110 by adjusting power supplied to the electric coil 211 of the friction drive unit 200.

The bouncing reduction device may further include an operation detection sensor 400 configured to detect an operating state of the friction drive unit 200. The operation detection sensor 400 may be disposed in an internal space of the solenoid housing 210 to detect the position of the solenoid mover 220 during operation.

The operation detection sensor 400 may be implemented as a proximity sensor that detects the proximity of a detection target by sensing change in magnetic field, and may be mounted at a rear end of the internal space of the solenoid housing 210, as shown in FIG. 4 and FIG. 5. Here, a sensor block 221 formed of a magnetic material may be coupled to a rear end of the solenoid mover 220 to be detected in proximity to the operation detection sensor 400.

Besides such a magnetic proximity sensor, various other types of sensors may be used as the operation detection sensor 400. For example, the operation detection sensor 400 may be implemented as a contact sensor that detects a detection target by sensing physical contact between the target and a sensing terminal. Here, the operation detection sensor 400 may be disposed at the rear end of the internal space of the solenoid housing 210 and may have a contact terminal formed on a front surface thereof. A sensor block 221 coupled to the rear end of the solenoid mover 220 may be formed of a conductive material. The sensor block 221 may be configured to be brought into contact with the contact terminal of the operation detection sensor 400 as the solenoid mover 220 is moved backward. The operation detection sensor 400 may be configured to activate an operation detection circuit upon contact between the sensor block 221 and the contact terminal, thereby enabling detection of the position of the solenoid mover 220 during operation.

This structure allows the operation detection sensor 400 to detect backward movement of the solenoid mover 220 through the sensor block 221 when the solenoid mover 220 is moved backward. Since generation of a detection signal of the operation detection sensor 400 indicates that the friction body 110 is separated from the guide rail 20 due to backward movement of the solenoid mover 220, the drive control unit 300 may be configured to receive the detection signal of the operation detection sensor 400 and transmit the received detection signal to the central control panel 500. The central control panel 500 may be configured to control the elevator car 10 to start moving only upon receiving the detection signal of the operation detection sensor 400 from the drive control unit 300. Upon receiving no detection signal from the drive control unit 330, the central control panel 500 may control the elevator car 10 maintain a stopped state and may generate and output a separate alarm signal.

As described above, vertical vibration experienced by the elevator car 10 when passengers board and alight from the elevator car 10 is canceled out by frictional force between the guide rail and the friction body 110 pressed against the guide rail 20 by activation of the friction drive unit 200, resulting in reduction of bouncing of the elevator car 10. However, despite reduction of vertical vibration achieved by frictional force between the friction body 110 and the guide rail 20, a load causing vertical vibration is transferred to the friction body 110. That is, the load due to passengers boarding and alighting from the elevator car 10 not only causes vibration of the elevator car 10, but also imposes a shear load on the friction body 110 frictionally contacting the guide rail 20.

The shear load imposed on the friction body 110 can cause vertical bending deformation or vertical displacement of the friction body 110, which, in turn, is transferred to the solenoid mover 220, causing damage to or failure of the solenoid mover 220.

To address this problem, in one embodiment of the present invention, the bouncing reduction device may further include a vertical reinforcing guide 250 configured to guide the friction body 110 of the friction module 100 to prevent vertical displacement of the friction body 110 while the friction body 110 contacts the guide rail 20. Referring to FIG. 2 and FIG. 6, the vertical reinforcing guide 250 may protrude forward from the front surface of the solenoid housing 210 such that an inner surface thereof slidingly contacts each of the upper and lower surfaces of the friction body 110.

Although it has been described that forward and backward movement of the friction body 110 is achieved by allowing the friction body 110 to be linearly moved along with the guide rod 121, there are various other ways to move the friction body 110 forward and backward. For example, as shown in FIG. 7, the friction body 110 and the friction drive unit 200 may be connected to each other by a separate connecting link 130 such that the friction body 110 is moved forward and backward along a curved path as the connecting link 130 is rotated. More specifically, the connecting link 130 is rotatably connected at one end thereof to the friction drive unit and is rotatably connected at the other end thereof the friction body 110 such that, when the friction drive unit 200 is activated to push the friction body 110 forward, the friction body 110 is moved forward along the curved path as the connecting link 130 is rotated. Accordingly, the friction pad 112 of the friction body 110 is brought into contact with the guide rail 20 in an oblique direction along the curved path, thereby allowing reduction of impact noise upon contact between the friction pad 112 and the guide rail 20. That is, as compared to when the friction pad 112 is brought into contact with the guide rail 20 in a perpendicular direction, when the friction pad 112 is brought into contact with the guide rail 20 in an oblique direction, impact noise upon contact between the friction pad 112 and the guide rail 20 can be relatively reduced.

Here, the elastic spring 120 configured to apply elastic force to the friction body 110 in a direction away from the guide rail 20 may be implemented as a leaf spring that resiliently presses the friction body 110 against the friction drive unit 200, as shown in FIG. 7.

FIG. 8 is a diagram illustrating a PWM control method used in the bouncing reduction device for elevator cars according to one embodiment of the present invention.

The drive control unit 300 according to one embodiment of the present invention controls the friction drive unit 200 by changing power supplied to the electric coil 211, as described above. Specifically, during activation of the friction drive unit 200 (during a period of time from T1 to T3), the drive control unit 300 may regulate power supplied to the electric coil 211 by a PWM control method.

For example, referring to FIG. 8, while the solenoid mover 220 is moved forward until the friction body 110 makes full contact with the guide rail 20 (during a period of time from T1 to T2), the PWM duty ratio of power supplied to the electric coil 211 may be adjusted to a relatively small value, and, after full contact is made between the friction body 110 and the guide rail 20 (during a period of time from T2 to T3), the PWM duty ratio of power supplied to the electric coil 211 may be adjusted to a relatively large value.

As such, by adjusting the PWM duty ratio to a relatively small value during forward movement of the solenoid mover 220 (during a period of time from time T1 to T2), corresponding reduction in speed of the solenoid mover 220 can be achieved, which, in turn, allows the friction body 110 to be brought into contact with the guide rail 20 at a relatively low speed, thereby reducing noise form contact between the friction body 110 and the guide rail 20. Once the friction body 110 makes full contact with the guide rail 20, the PWM duty ratio may be adjusted to a relatively large value during a subsequent period (from T2 to T3) to increase frictional force between the friction body 110 and the guide rail 20 to a maximum designed value.

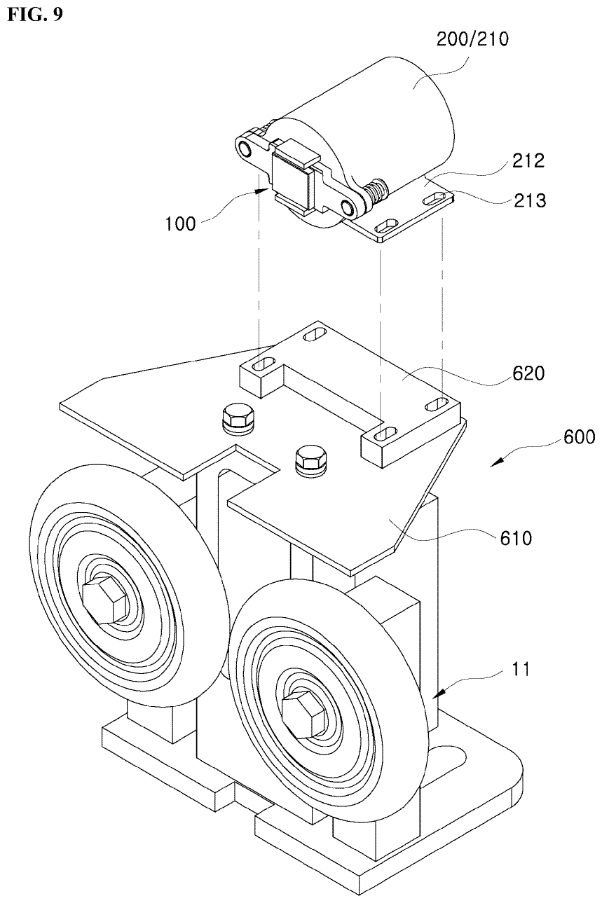

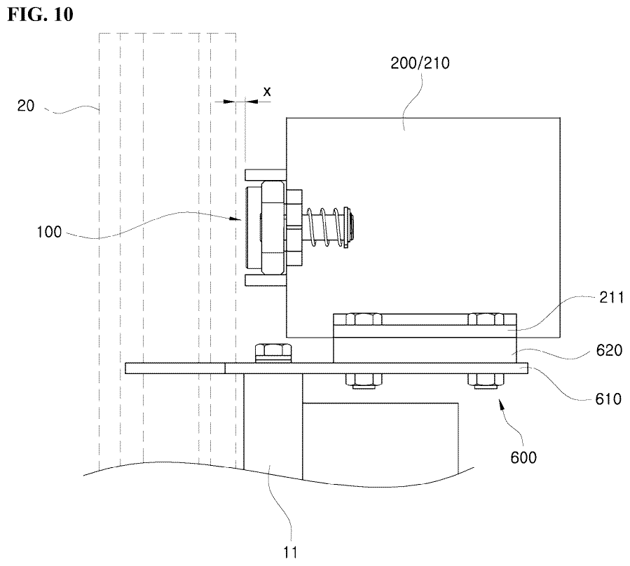

FIG. 9 is a schematic partial exploded perspective view of a coupling module of the bouncing reduction device for elevator cars according to one embodiment of the present invention, and FIG. 10 is a schematic side view illustrating a coupling structure of the bouncing reduction device for elevator cars according to one embodiment of the present invention.

Referring to FIG. 9 and FIG. 10, the friction drive unit 200 according to one embodiment of the present invention is detachably coupled to an upper portion of the guide roller device 11 of the elevator car through a separate coupling module 600.

As described above, the friction module 100 is coupled to the solenoid housing 210 of the friction drive unit 200 in a back-and-forth moveable manner, and the solenoid housing 210 of the friction drive unit 200 is coupled to the upper portion of the guide roller device 11 through the coupling module 600.

The solenoid housing 210 has a cylindrical shape and includes a coupling flange 212 formed at a lower end of an outer surface thereof to be coupled to the coupling module 600, wherein the coupling flange 212 includes a bolt coupling hole 213 formed therethrough and allowing a coupling bolt to be coupled thereto.

The coupling module 600 may include: a support plate 610 detachably coupled to the upper portion of the guide roller device 11; and an adapter block 620 coupled to an upper surface of the support plate 610 and having an upper surface allowing the solenoid housing 210 of the friction drive unit 200 to be seated thereon and coupled thereto.

The support plate 610 is horizontally disposed at an upper end of the guide roller device 11 and is coupled to the guide roller device unit 11 through a coupling bolt. The support plate 610 is configured to support both the friction drive unit 200 and the friction module 100. To secure structural stability, the support plate 610 may be formed of a relatively rigid material and may have a relatively rigid shape. In addition, although not shown in the drawings, a separate reinforcing rib (not shown) may be further provided to the support plate 610 to prevent bending deformation of the support plate 610 about a horizontal axis thereof.

In addition, the support plate 610 may extend forward to cover a space above a guide roller of the guide roller device 11 (a guide roller configured to roll on the guide rail). In this way, the support plate 610 can double as a barrier for protection of the guide roller, such as prevention of intrusion of foreign matter into the guide roller.

The adapter block 620 has an upper surface allowing the friction drive unit 200 to be seated thereon and is configured to adjust the position of the friction drive unit 200 in a front-to-rear direction with respect to the guide rail 20, with the friction drive unit 200 seated thereon. To this end, the adapter block 620 may include a position adjustment slot 621 formed at a location corresponding to the bolt coupling hole 213 formed through the coupling flange 212 of the solenoid housing 210. The position adjustment slot 621 extends in a front-to-rear direction toward the guide rail 20. It will be understood that the bolt coupling hole 213 formed through the coupling flange 212 of the solenoid housing 210 may also extend in a front-to-rear direction toward the guide rail 20.

As such, by adjusting the position of the friction drive unit 200 in the front-to-rear direction using the adapter block 620, a gap X between the friction module 100 and the guide rail 20 can be adjusted. In particular, this feature allows setting of the gap X during initial installation of the bouncing reduction device, thereby improving the operating accuracy of the device.

The adapter block 620 may perform both a function of securing the friction drive unit 200 in a position-adjustable manner and a function of cushioning and supporting the friction drive unit 200. To this end, the adapter block 620 may be formed of a relatively less rigid material, for example, a material capable of performing a cushioning function, such as a rubber pad with a reinforcing plate embedded therein. As such, by cushioning the friction drive unit 200 using the adapter block 620, shock loads transferred from the elevator car can be reduced, thereby improving the operating accuracy of the friction drive unit 200 while reducing the risk of failure.

As described above, the coupling module 600 including the support plate 610 and the adapter block 620 allows easy mounting of the friction drive unit 200 on the guide roller device 11 of the elevator car 10. In particular, the coupling module 600 according to the present invention allows easy retrofitting of the bouncing reduction device to existing elevator cars without any structural modifications.

Although the bouncing reduction device according to the present invention has been described as being mounted on the guide roller device 11 installed at the upper portion of the elevator car, the present invention is not limited thereto and the bouncing reduction device may be mounted on a guide roller device 11 installed at a lower portion of the elevator car.

The bouncing reduction device, specifically the friction drive unit 200, may be detachably coupled to an upper portion of the guide roller device 11 installed at the upper portion of the elevator car through the coupling module 600, as described above, or may be detachably coupled to a lower portion of the guide roller device 11 installed at the lower portion of the elevator car through the coupling module 600.

Here, the support plate 610 of the coupling module 600 is detachably coupled to the lower portion of the guide roller device 11, and the adapter block 620 of the coupling module 600 is coupled to the lower surface of the support plate 610. The solenoid housing 210 is seated on and coupled to the lower surface of the adapter block 620.

As such, a coupling structure of the bouncing reduction device for the guide roller device 11 at the lower portion of the elevator car is vertically symmetrical to a coupling structure of the bouncing reduction device for the guide roller device 11 at the upper portion of the elevator car. Generally, a pair of guide roller devices 11 is installed at the upper and lower portions of the elevator car, respectively, to be vertically symmetrical to each other. According to the present invention, a pair of bouncing reduction devices may be coupled to the upper guide roller device and the lower guide roller device, respectively, to be vertically symmetrical to each other, or a single bouncing reduction device may be coupled to one of the upper and lower guide roller devices. Since the coupling structure between the bouncing reduction device and the lower guide roller device is vertically symmetrical to the coupling structure between the bouncing reduction device and the upper guide roller device described above, detailed description thereof will be omitted.

Although some exemplary embodiments have been described herein, it should be understood that these embodiments are given by way of illustration only and that various modifications, variations, and alterations can be made by those skilled in the art without departing from the spirit and scope of the invention. Accordingly, it should be understood that the embodiments disclosed herein are intended to illustrate and not to limit the technical ideas of the invention, and the scope of the technical ideas of the invention is not limited by the embodiments. The scope of protection of the invention shall be construed in accordance with the following claims and all technical ideas within the scope of equivalents thereto shall be construed to be included within the scope of the invention.

1. A bouncing reduction device for elevator cars, configured to reduce a bouncing phenomenon in which an elevator car configured to move along a guide rail in a hoistway vibrates in a vertical direction when passengers board and alight from the elevator car, the bouncing reduction device comprising:
a friction module coupled to the elevator to be pressed against the guide rail;
a friction drive unit coupled to the elevator car and configured to force the friction module to be pressed against the guide rail;
a drive control unit configured to control activation and deactivation of the friction drive unit in response to an operating state signal of the elevator car from a separate central control panel,
wherein the friction module is pressed against the guide rail upon activation of the friction drive unit and is separated from the guide rail upon deactivation of the friction drive unit.

2. The bouncing reduction device according to claim 1, wherein the friction module is moved to be pressed against the guide rail upon activation of the friction drive unit and is resiliently returned to an original position thereof to be separated from the guide rail upon deactivation of the friction drive unit.

3. The bouncing reduction device according to claim 1, wherein the friction module comprises:
a friction body coupled to one side of the friction drive unit to be movable back and forth and configured to be moved forward and pressed against the guide rail by activation of the friction drive unit; and
an elastic spring applying elastic force to the friction body in a direction away from the guide rail.

4. The bouncing reduction device according to claim 3, wherein the friction body comprises:
a movable block coupled to the one side of the friction drive unit to be movable back and forth; and
a friction pad coupled to a front surface of the movable block to be brought into contact with the guide rail.

5. The bouncing reduction device according to claim 3, wherein the friction drive unit comprises:
a solenoid housing having an electric coil disposed therein; and
a solenoid mover coupled to the solenoid housing to be movable back and forth and configured to be linearly moved by change in power supplied to the electric coil,
wherein the friction body is pushed forward away from the solenoid housing by the solenoid mover upon forward movement of the solenoid mover.

6. The bouncing reduction device according to claim 5, wherein the drive control unit is configured to control the friction drive unit by changing power supplied from a separate power supply to the electric coil.

7. The bouncing reduction device according to claim 6, wherein, during activation of the friction drive, the drive control unit regulates power supplied to the electric coil by a PWM control method in which a PWM duty ratio of power supplied to the electric coil is adjusted to a relatively small value while the solenoid mover is moved forward until the friction body makes full contact with the guide rail, and is adjusted to a relatively large value after full contact is made between the friction body and the guide rail.

8. The bouncing reduction device according to claim 3, further comprising:
a vertical reinforcing guide configured to guide the friction body of the friction module to prevent vertical displacement of the friction body while the friction body contacts the guide rail.

9. The bouncing reduction device according to claim 1, wherein the drive control unit is configured to receive a door open/close signal of the elevator car from the central control panel and to activate or deactivate the friction drive unit according to the door open/close signal.

10. The bouncing reduction device according to claim 1, further comprising:
an operation detection sensor configured to detect an operating state of the friction drive unit,
wherein the drive control unit is configured to receive a detection signal of the operation detection sensor and transmit the detection signal to the central control panel.

11. The bouncing reduction device according to claim 1, wherein the drive control unit is configured to receive an operating intensity signal of the friction drive unit from the central control panel and to change operating intensity of the friction drive unit according to the received operating intensity signal.

12. The bouncing reduction device according to claim 1, wherein the friction drive unit is detachably coupled to a guide roller device of the elevator car through a separate coupling module, and the friction module is coupled to the friction drive unit to be movable back and forth by the friction drive unit.

13. The bouncing reduction device according to claim 12, wherein the coupling module comprises:
a support plate detachably coupled to one end of the guide roller device; and
an adapter block coupled to one surface of the support plate and having an upper portion allowing the friction drive unit to be seated thereon and coupled thereto.

14. The bouncing reduction device according to claim 13, wherein the adapter block is configured to adjust a position of the friction drive unit in a front-to-rear direction with respect to the guide rail, with the friction drive unit seated on the adapter block.

15. The bouncing reduction device according to claim 13, wherein the support plate extends in a horizontal direction to cover a space outside a guide roller of the guide roller device.
